(19) United States
(12) Patent Application Publication
(10) Pub. No.: US 2025/0201845 A1
(43) Pub. Date: Jun. 19, 2025

(54) POWDERY BINDER FOR SECONDARY BATTERY POSITIVE ELECTRODE AND USE OF SAME

(71) Applicant: TOAGOSEI CO., LTD., Tokyo (JP)

(72) Inventors: Masaki SHIMADA, Nagoya-shi (JP); Naohiko SAITO, Nagoya-shi (JP); Shinya KANBE, Nagoya-shi (JP); Takashi HASEGAWA, Nagoya-shi (JP)

(73) Assignee: TOAGOSEI CO., LTD., Tokyo (JP)

(21) Appl. No.: 18/848,037

(22) PCT Filed: Mar. 20, 2023
(86) PCT No.: PCT/JP2023/010793

§ 371 Date: Sep. 17, 2024

(30) Foreign Application Priority Data
Mar. 24, 2022 (JP) 2022-049083

(51) Int. Cl. H01M 4/62; C08F 212/08; C08F 220/14; H01M 4/02; H01M 4/131

(52) U.S. Cl. CPC H01M 4/622; C08F 212/08; C08F 220/14; H01M 4/131; C08F 2800/20; H01M 2004/028

(57) ABSTRACT

The present invention provides a powdery binder for a secondary battery positive electrode, which is capable of improving productivity of the secondary battery positive electrode as well as dispersibility of the binder in an active material and adhesion to the active material. In addition, a powdery particle composite containing the powdery binder is also provided. A powdery binder for a secondary battery positive electrode, comprising a non-crosslinked polymer having a glass transition temperature of 60° C. or higher and 150° C. or lower. A powdery particle composite including a positive electrode active material and the powdery binder for a secondary battery positive electrode.

### TECHNICAL FIELD

The present specification relates to a powdery binder for a secondary battery positive electrode and uses of the powdery binder.

### BACKGROUND ART

As a secondary battery, various power storage devices such as a nickel-hydrogen secondary battery, a lithium ion secondary battery, and an electric double layer capacitor have been put into practical use. Electrodes used in these secondary batteries are prepared by applying a composition for forming an electrode mixture layer containing an active material, a binder, and the like onto a current collector, drying the composition, and the like. For example, in a lithium ion secondary battery, an aqueous binder containing styrene-butadiene rubber (SBR) latex and carboxymethylcellulose (CMC) is used as a binder used in a composition for a negative electrode mixture layer. On the other hand, an N-methyl-2-pyrrolidone (NMP) solution of polyvinylidene fluoride (PVDF) is widely used as a binder used for a positive mixture layer.

In recent years, with the expansion of applications of various secondary batteries, there has been an increasing demand for improvement in energy density, reliability, durability, and productivity of secondary batteries. Under such circumstances, a secondary battery electrode is also required to achieve both higher performance and productivity.

A secondary battery electrode is obtained by laminating an electrode mixture layer in which an active material and a conductive auxiliary agent are bound with a binder on a current collecting foil. The electrode is usually produced by a method of applying an electrode slurry containing an active material, a conductive auxiliary agent, a binder (binder), and the like onto a current collector and drying the slurry, or the like. For example, in a process of producing a secondary battery positive electrode, an electrode slurry containing a positive electrode active material, a conductive auxiliary agent, a binder, and an organic solvent is used.

However, in the case of removing the organic solvent from the electrode slurry, a large amount of heat energy is required such as a long drying time, and therefore it is difficult to improve productivity.

Therefore, as a method of producing a positive electrode for a secondary battery, a method using a mixed powder containing an active material (hereinafter, also simply referred to as a “mixed powder”) instead of using an electrode slurry (so-called “dry blending”) has been proposed.

As the mixed powder, for example, Patent Literature 1 describes a mixed powder containing an active material powder and a binder powder, and specifically discloses, in Examples, a mixed powder containing a lithium manganate powder (positive electrode active material) as the active material powder and a PVDF powder as the binder powder. It is shown that an electrode mixture layer (active material layer) having high film thickness accuracy and good load characteristics can be formed without using an electrode slurry (active material paste) by attaching the above-described mixed powder to a current collector by powder coating and heating the mixed powder attached to the current collector to higher than or equal to the softening temperature (150° C.) of the binder to fuse the mixed powder.

In addition, Patent Literature 2 describes a mixed powder (powdery composite particles) which includes a polymer having a glass transition temperature of 35 to 80° C. and a volume-based D50 average particle diameter of primary particles of 80 to 1000 nm and which has a volatile content at 120° C. of less than 1% by weight, and specifically discloses, in Examples, a mixed powder containing an NMC powder (LiNi_{1/3}Co_{1/3}Mn_{1/3}O₂, positive electrode active material) as an active material powder and a “crosslinked polymer having a structural unit derived from a non-crosslinkable monomer (main component: ethyl methacrylate) and a crosslinkable monomer (allyl methacrylate)” as a binder powder. It is shown that since an electrode slurry is not used at the time of forming an electrode mixture layer, productivity of a secondary battery electrode is excellent, and since a water-soluble polymer component is not required as a dispersant, resistance can be reduced, and an electrode excellent in thickness accuracy and flexibility of a resulting electrode can be formed.

### CITATION LIST

### Patent Literature

Patent Literature 1: JP-A-2001-351616
Patent Literature 2: WO 2014/192652 A

### SUMMARY OF INVENTION

### Problems to be Solved by Invention

With the powdery binder (PVDF) disclosed in Patent Literature 1, a secondary battery electrode can be produced by dry blending without using an electrode slurry. However, since it is necessary to set the heating fusion temperature to 150° C. or higher (200° C. in Examples) after attaching the mixed powder to the surface of the current collector, there is a problem in terms of productivity, and adhesion of the powdery binder to the active material was sometimes insufficient.

On the other hand, the powdery binder (the crosslinked polymer) disclosed in Patent Literature 2 can be pressure-molded (compression-treated) at a temperature lower than that of the PVDF after the mixed powder is attached to the surface of the current collector, but fusion between binders easily occurs, and dispersibility of the binder in the active material and adhesion to the active material were sometimes insufficient.

The present invention has been made in view of such circumstances, and an object thereof is to provide a powdery binder for a secondary battery positive electrode capable of improving productivity of a secondary battery positive electrode and improving dispersibility of the binder in an active material and adhesion of the binder to an active material. A further object is to provide a powdery particle composite containing the powdery binder, a secondary battery positive electrode obtained using the powdery particle composite, and a secondary battery.

### Solution to Problems

As a result of intensive studies to solve the above problems, the present inventors have found that use of a powdery binder for a secondary battery positive electrode which includes a non-crosslinked polymer having a glass transition temperature in a specific range can improve productivity of a secondary battery positive electrode and can improve dispersibility of the binder in an active material and adhesion of the binder to an active material, thereby completing the present invention.

The present invention is as follows.

[1] A powdery binder for a secondary battery positive electrode, including a non-crosslinked polymer having a glass transition temperature of 60° C. or higher and 150° C. or lower.

[2] The powdery binder for a secondary battery positive electrode according to [1], in which the non-crosslinked polymer has a structural unit derived from a non-crosslinkable ethylenically unsaturated monomer.

[3] The powdery binder for a secondary battery positive electrode according to [2], in which the non-crosslinkable ethylenically unsaturated monomer includes a non-crosslinkable aromatic vinyl monomer or a non-crosslinkable ethylenically unsaturated carboxylic acid ester monomer.

[4] The powdery binder for a secondary battery positive electrode according to any one of [1] to [3], in which the non-crosslinked polymer has 5 mass % or less of a structural unit derived from a non-crosslinkable ethylenically unsaturated carboxylic acid monomer with respect to all structural units of the non-crosslinked polymer.

[5] The powdery binder for a secondary battery positive electrode according to any one of [1] to [4], in which a particle diameter of the non-crosslinked polymer is 80 nm to 800 nm as a volume-based median diameter (D50) measured by a dynamic light scattering method.

[6] A powdery particle composite including a positive electrode active material and the powdery binder for a secondary battery positive electrode according to any one of [1] to [5].

[7] A secondary battery positive electrode including a mixture layer formed from the powdery particle composite according to [6] on a surface of a current collector.

[8] A secondary battery including the secondary battery positive electrode according to [7].

### Effects of Invention

According to the powdery binder for a secondary battery positive electrode of the present invention, the productivity of a secondary battery positive electrode can be improved, and the dispersibility of the binder in an active material and adhesion of the binder to an active material can be improved.

### DESCRIPTION OF EMBODIMENTS

A powdery binder for a secondary battery positive electrode (hereinafter, also referred to as the “present binder”) of the present invention includes a non-crosslinked polymer (hereinafter, also referred to as the “present non-crosslinked polymer”) having a glass transition temperature of 60° C. or higher and 150° C. or lower. Furthermore, the present binder is used as a powdery particle composite containing a positive electrode active material, and a positive electrode mixture layer is formed from the powdery particle composite on the surface of a current collector such as an aluminum foil, so that a secondary battery positive electrode of the present invention is obtained.

Here, the term “powdery” in the present binder means that the solid content concentration is 85 mass % or more, and the method for measuring the solid content concentration will be described below. Particularly in the case of producing a positive electrode for a secondary battery by dry blending, the solid content concentration is more preferably 90 mass % or more, further preferably 95 mass % or more, still further preferably 97 mass % or more, and still further preferably 98 mass % or more.

### (Method of Measuring Solid Content Concentration)

About 0.5 g of the polymer was collected in a weighing bottle [weight of weighing bottle=B (g)] of which the weight had been measured in advance, and was accurately weighed together with the weighing bottle [W₀ (g)]. Then, the polymer was housed in a circulation dryer together with the weighing bottle and dried at 155° C. for 45 minutes. The weight at that time was measured together with the weighing bottle [W₁ (g)], and the solid concentration was determined by the following mathematical expression (1).

$$Solid content concentration ( \% ) = ( {W}_{1} - B ) / ( {W}_{0} - B ) \times 100 \qquad ( 1 )$$

Hereinafter, the present binder will be described together with its constituents. Furthermore, a powdery particle composite containing the present binder, a secondary battery positive electrode, and a secondary battery will also be described in detail.

Note that in the present specification, “(meth)acryl” means acryl and/or methacryl, and “(meth)acrylate” means acrylate and/or methacrylate. Further, a “(meth)acryloyl group” means an acryloyl group and/or a methacryloyl group.

In the numerical ranges described in stages in the present specification, the upper limit value or the lower limit value described in one numerical range may be replaced with the upper limit value or the lower limit value of a numerical range described in another stage, and the upper limit value or the lower limit value of the numerical range may be replaced with values shown in Examples.

### 1. Present Binder

Since the present binder includes the present non-crosslinked polymer, the polymer melts under compression treatment conditions at a relatively high temperature, and covers a positive electrode active material. Therefore, adhesion of the binder to an active material can be improved. On the other hand, since the glass transition temperature of the present non-crosslinked polymer is 60° C. or higher and 150° C. or lower, fusion between binders does not occur when the powdery particle composite is produced, and the dispersibility of the binder in an active material can be improved.

From the viewpoint that the dispersibility of the binder in an active material can be improved, the glass transition temperature (hereinafter, also simply referred to as “Tg”) of the present non-crosslinked polymer is preferably 65° C. or higher and 150° C. or lower, more preferably 70° C. or higher and 140° C. or lower, further preferably 75° C. or higher and 130° C. or lower, still further preferably 80° C. or higher and 130° C. or lower, still further preferably 85° C. or higher and 120° C. or lower, and still further preferably 90° C. or higher and 110° C. or lower.

In the present specification, Tg can be measured by a differential scanning calorimeter (DSC) described in Examples.

### <Structural Unit of Present Non-Crosslinked Polymer>

The structural unit of the present non-crosslinked polymer does not substantially include a structural unit derived from a crosslinkable monomer, and includes a structural unit derived from a monomer (hereinafter, also referred to as a “non-crosslinkable monomer”) other than the crosslinkable monomer.

The non-crosslinkable monomer is not particularly limited, but preferably includes a structural unit derived from a non-crosslinkable ethylenically unsaturated monomer. The content of the structural unit is preferably 50 mass % or more and 100 mass % or less, more preferably 60 mass % or more and 100 mass % or less, further preferably 70 mass % or more and 100 mass % or less, and still further preferably 80 mass % or more and 100 mass % or less with respect to all structural units of the present non-crosslinked polymer.

Examples of the non-crosslinkable ethylenically unsaturated monomer include a non-crosslinkable aromatic vinyl monomer (hereinafter, also referred to as a “monomer (a1)”), a non-crosslinkable ethylenically unsaturated carboxylic acid ester monomer (hereinafter, also referred to as a “monomer (a2)”), a non-crosslinkable ethylenically unsaturated carboxylic acid monomer (hereinafter, also referred to as a “monomer (a3)”), a non-crosslinkable nitrile group-containing ethylenically unsaturated monomer, non-crosslinkable (meth)acrylamide and derivatives thereof, and a non-crosslinkable maleimide compound.

Among them, it is preferable to contain a structural unit derived from the monomer (a1) or the monomer (a2) from the viewpoint of improving the dispersibility of the binder in an active material and the adhesion to an active material.

<Structural Unit Derived from Monomer (a1) and Monomer (a2)>

Examples of the monomer (a1) include styrene, α-methylstyrene, vinylnaphthalene, and isopropenylnaphthalene. One of these may be used alone, or two or more thereof may be used in combination.

The content of the monomer (a1) component in the present non-crosslinked polymer is not particularly limited, but is preferably 50 mass % or more and 100 mass % or less, more preferably 60 mass % or more and 100 mass % or less, further preferably 70 mass % or more and 100 mass % or less, and still further preferably 80 mass % or more and 100 mass % or less with respect to all structural units of the present non-crosslinked polymer.

The monomer (a2) is preferably a (meth)acrylic acid ester monomer. Examples thereof include (meth)acrylic acid alkyl ester compounds such as methyl (meth)acrylate, ethyl (meth)acrylate, n-butyl (meth)acrylate, isobutyl (meth)acrylate, and 2-ethylhexyl (meth)acrylate;
aromatic (meth)acrylic acid ester compounds such as phenyl (meth)acrylate, phenylmethyl (meth)acrylate, phenylethyl (meth)acrylate, and phenoxyethyl (meth)acrylate;
(meth)acrylic acid alkoxyalkyl ester compounds such as 2-methoxyethyl (meth)acrylate and 2-ethoxyethyl (meth)acrylate;
and (meth)acrylic acid hydroxyalkyl ester compounds such as 2-hydroxyethyl (meth)acrylate, 3-hydroxypropyl (meth)acrylate, and 4-hydroxybutyl (meth)acrylate. One of these may be used alone, or two or more thereof may be used in combination.

The content of the monomer (a2) component in the present non-crosslinked polymer is not particularly limited, but is preferably 1 mass % or more and 100 mass % or less, more preferably 1 mass % or more and 50 mass % or less, further preferably 1 mass % or more and 30 mass % or less, and still further preferably 1 mass % or more and 20 mass % or less with respect to all structural units of the present non-crosslinked polymer.

<Structural Unit Derived from Monomer (a3)>

Examples of the monomer (a3) include: (meth)acrylic acid, itaconic acid, crotonic acid, maleic acid, and fumaric acid; (meth)acrylamide alkyl carboxylic acids such as (meth)acrylamide hexanoic acid and (meth)acrylamide dodecanoic acid; and monohydroxyethyl succinate (meth)acrylate, ω-carboxy-caprolactone mono(meth)acrylate, and β-carboxyethyl (meth)acrylate. One of these may be used alone, or two or more thereof may be used in combination.

The amount of the structural unit derived from the monomer (a3) in the present non-crosslinked polymer is not particularly limited, but may be, for example, 15 mass % or less with respect to all structural units of the present non-crosslinked polymer. When the component (a3) is contained within such a range, the mechanical stability of the present non-crosslinked polymer can be improved. The content is preferably 13 mass % or less, more preferably 11 mass % or less, further preferably 9 mass % or less, still further preferably 7 mass % or less, still further preferably 5 mass % or less, and still further preferably 3 mass % or less.

### <Other Structural Units>

Examples of other structural units in the present non-crosslinked polymer include a non-crosslinkable nitrile group-containing ethylenically unsaturated monomer, non-crosslinkable (meth)acrylamide and derivatives thereof, and a non-crosslinkable maleimide compound. The amount of the above-described other structural units is, for example, 50 mass % or less, for example, 30 mass % or less, for example, 10 mass % or less, for example, 5 mass % or less, or, for example, 1 mass % or less with respect to the total amount of monomers constituting the non-crosslinked polymer.

Examples of the non-crosslinkable nitrile group-containing ethylenically unsaturated monomer include: (meth)acrylonitrile; (meth)acrylic acid cyanoalkyl ester compounds such as cyanomethyl (meth)acrylate and cyanoethyl (meth)acrylate; cyano group-containing unsaturated aromatic compounds such as 4-cyanostyrene and 4-cyano-α-methylstyrene; and vinylidene cyanide. One of these may be used alone, or two or more thereof may be used in combination.

Examples of the non-crosslinkable (meth)acrylamide derivative include: N-alkyl (meth)acrylamide compounds such as N-isopropyl (meth)acrylamide and N-t-butyl (meth)acrylamide; N-alkoxyalkyl (meth)acrylamide compounds such as N-n-butoxymethyl (meth)acrylamide and N-isobutoxymethyl (meth)acrylamide; N,N-dialkyl (meth)acrylamide compounds such as N,N-dimethyl (meth)acrylamide and N,N-diethyl (meth)acrylamide, and cyclic (meth)acrylamide compounds such as 4-acryloylmorpholine. One of these may be used alone, or two or more thereof may be used in combination.

Examples of the non-crosslinkable maleimide compound include maleimide and N-substituted maleimide compounds. Examples of the N-substituted maleimide compound include N-alkyl-substituted maleimide compounds such as N-methylmaleimide, N-ethylmaleimide, N-n-propylmaleimide, N-isopropylmaleimide, N-n-butylmaleimide, N-isobutylmaleimide, N-tert-butylmaleimide, N-pentylmaleimide, N-hexylmaleimide, N-heptylmaleimide, N-octylmaleimide, N-laurylmaleimide, and N-stearylmaleimide; N-cycloalkyl-substituted maleimide compounds such as N-cyclopentylmaleimide and N-cyclohexylmaleimide; and N-aryl-substituted maleimide compounds such as N-phenylmaleimide, N-(4-hydroxyphenyl) maleimide, N-(4-acetylphenyl) maleimide, N-(4-methoxyphenyl) maleimide, N-(4-ethoxyphenyl) maleimide, N-(4-chlorophenyl) maleimide, N-(4-bromophenyl) maleimide, and N-benzylmaleimide. One of these may be used alone, or two or more thereof may be used in combination.

### <Particle Diameter of Present Non-Crosslinked Polymer>

In terms of excellent adhesion to an active material, the particle diameter of the present non-crosslinked polymer, as the volume-based median diameter (D50) measured by a dynamic light scattering method, is, for example, 80 nm to 950 nm, preferably 80 nm to 800 nm, more preferably 80 nm to 750 nm, further preferably 80 nm to 700 nm, still further preferably 80 nm to 650 nm, and still further preferably 80 nm to 600 nm.

In the present specification, the particle diameter can be measured by a dynamic light scattering method described in Examples.

### <Method of Producing Present Non-Crosslinked Polymer>

The present non-crosslinked polymer can be produced by using a known polymerization method such as solution polymerization, precipitation polymerization, suspension polymerization, or emulsion polymerization, and the method is appropriately selected depending on the molecular weight, composition, or the like.

As a polymerization initiator, a known polymerization initiator such as an azo-based compound, an organic peroxide, or an inorganic peroxide can be used, but a polymerization initiator is not particularly limited. The use conditions can be adjusted so as to obtain an appropriate radical generation amount by a known method such as thermal initiation, redox initiation using a reducing agent in combination, or UV initiation.

In addition, for the purpose of, for example, adjusting the molecular weight, a known chain transfer agent may be used as necessary.

Here, among the polymerization methods, emulsion polymerization is preferable in that the non-crosslinked polymer having the above particle diameter can be obtained and in that the effect of the present invention is large.

Examples of the emulsion polymerization method include a batch reaction in which a monomer, a surfactant, and water are all charged in a reaction tank and reacted, and a dropping reaction in which a monomer is gradually dropped into a reaction tank and reacted. Among them, the dropping reaction is preferable from the viewpoint of easily controlling the heat generation in the polymerization reaction. In addition, in order to further improve the polymerization stability, the dropping reaction is preferably performed by mixing and stirring a monomer, water, and a surfactant to form a monomer preemulsion in an emulsified state and then dropping the mixture. At this time, a solvent mainly containing water is present in the reaction tank. The solvent is preferably mixed with a surfactant. Furthermore, the solvent is preferably warmed in advance, and the warming conditions are, for example, 50 to 120° C. and 70 to 100° C.

The emulsion polymerization is preferably performed in the presence of at least one of a surfactant and a protective colloid. The ionic species of the surfactant is preferably an anion, a cation, or a nonion and more preferably an anion or a nonion. In addition, a polymerizable surfactant having an ethylenically unsaturated double bond can also be used.

The anionic surfactant refers to a surfactant which can be ionized in an aqueous solution and in which a portion exhibiting hydrophilicity becomes an anion. The nonionic surfactant refers to a surfactant that exhibits surfactant activity without ions being dissociated in an aqueous solution. The cationic surfactant refers to a surfactant which can be ionized in an aqueous solution and in which a portion exhibiting hydrophilicity becomes a cation. The polymerizable surfactant is an anionic or nonionic surfactant having one or more radically polymerizable unsaturated double bonds in the molecule.

The above-described surfactants can be used alone or in combination of two or more. The blending amount of the surfactant is not particularly limited, but is preferably 0.1 to 20 parts by mass with respect to 100 parts by mass of a monomer mixture (in the present specification, the “monomer mixture” is a mixture containing a monomer and a chain transfer agent). When an appropriate amount of the surfactant is used, the mechanical stability of resin particles is further improved, and when an appropriate amount of the polymerizable surfactant is used, the mechanical stability is further improved. When the blending amount is less than 0.1 part by mass, it is difficult to ensure emulsion stability. When the blending amount is more than 20 parts by mass, water resistance is significantly deteriorated.

For the emulsion polymerization, it is preferable to use a radical polymerization initiator (hereinafter, also referred to as a “polymerization initiator”). As the polymerization initiator, a known oil-soluble polymerization initiator or water-soluble polymerization initiator can be used.

Examples of the oil-soluble initiator include organic peroxides such as benzoyl peroxide, tertiary butyloxybenzoate, tertiary butylhydroperoxide, tertiary butylperoxy-2 ethylhexanoate, tertiary butylperoxy-3,5,5,trimethylhexanoate, ditertiary butylperoxide, cumene hydroperoxide, and p-menthane hydroperoxide; and azobis compounds such as 2,2′-azobisisobutyronitrile, 2,2′-azobis-2,4-dimethylvaleronitrile, 2,2′-azobis (4-methoxy-2,4-dimethylvaleronitrile), and 1,1′-azobis-cyclohexane-1-carbonitrile.

Examples of the water-soluble polymerization initiator include ammonium persulfate, sodium persulfate, potassium persulfate, hydrogen peroxide, and 2,2′-azobis(2-methylpropionamidine) dihydrochloride.

In the emulsion polymerization, a reducing agent can be used in combination with the polymerization initiator. This can promote the polymerization reaction. Examples of such a reducing agent include reducing organic compounds such as metal salts of ascorbic acid, erythorbic acid, tartaric acid, citric acid, glucose, formaldehyde sulfoxylate, and the like, reducing inorganic compounds such as sodium sulfite, sodium bisulfite, sodium metabisulfite (SMBS), and sodium hyposulfite, ferrous chloride, Rongalite, and thiourea dioxide.

For the emulsion polymerization, it is preferable to use a water-soluble polymerization initiator. It is preferable to use 0.05 to 5 parts by mass of the polymerization initiator with respect to 100 parts by mass of the monomer mixture. It is preferable to use 0.01 to 2.5 parts by mass of the reducing agent with respect to 100 parts by mass of the monomer mixture.

In the emulsion polymerization, a buffer, a chain transfer agent, a basic compound, or the like can be used as necessary. Examples of the buffer include sodium acetate, sodium citrate, and sodium bicarbonate. Examples of the chain transfer agent include 2-mercaptoethanol, octyl mercaptan, tertiary dodecyl mercaptan, lauryl mercaptan, stearyl mercaptan, 2-ethylhexyl mercaptoacetate, octyl mercaptoacetate, 2-ethylhexyl mercaptopropionate, and octyl mercaptopropionate.

Furthermore, the present binder can be obtained by drying a non-crosslinked polymer obtained by the above-described polymerization method. The drying method is not particularly limited as long as the non-crosslinked polymer can be dried in a redispersible state without being excessively fused. Examples thereof include a method of drying an aqueous dispersion with a circulation dryer (for example, 70° C.), a method of spray-drying an aqueous dispersion of the non-crosslinked polymer, and a method of drying with a rotary evaporator. Further, it is more preferable to dry under vacuum after spray drying or drying with a rotary evaporator.

The drying temperature is preferably lower than the minimum film-forming temperature between non-crosslinked polymers, from the viewpoint of being able to remove moisture in a redispersible state without excessively fusing the non-crosslinked polymer. When the drying temperature is too high, the non-crosslinked polymers form a film, and thus it is difficult to redisperse the non-crosslinked polymer.

From the viewpoint that the non-crosslinked polymer can be dried in a redispersible state, the minimum film-forming temperature of the present non-crosslinked polymer is preferably 60° C. or higher, further preferably 70° C. or higher, and still further preferably 80° C. or higher. When the minimum film-forming temperature is too low, it is difficult to dry the non-crosslinked polymer such that the non-crosslinked polymer is not excessively fused.

Here, the minimum film-forming temperature is the minimum temperature at which a film of the non-crosslinked polymer is formed. The minimum film-forming temperature can be measured in accordance with JIS K6828-2 (2003). Specifically, an aqueous dispersion of the non-crosslinked polymer is applied onto a flat plate such as an iron plate having an appropriate temperature gradient so as to have a thickness of about 100 μm and dried, and the boundary temperature between the portion in which a film was formed and the portion in which a film was not formed is measured. Here, since the portion in which a film was formed becomes transparent while the portion in which a film was not formed becomes cloudy, the boundary between the portion in which a film was formed and the portion in which a film was not formed can be visually confirmed. In addition, since the portion in which a film was not formed is subjected to powder fall-off when the flat plate after applied with an aqueous dispersion of the non-crosslinked polymer and dried is rubbed, the boundary between the portion in which a film was formed and the portion in which a film was not formed can also be confirmed by the presence or absence of powder fall-off.

### 2. Powdery Particle Composite

The powdery particle composite of the present invention includes a positive electrode active material and the present binder.

The use amount of the present binder in the present powdery particle composite is, for example, 0.1 part by mass or more and 10 parts by mass or less with respect to 100 parts by mass of the total amount of the positive electrode active material. Further, the use amount is, for example, 0.2 part by mass or more and 8 parts by mass or less, for example, 0.3 part by mass or more and 5 parts by mass or less, and, for example, 0.4 part by mass or more and 5 parts by mass or less. When the use amount of the present binder is 0.1 part by mass or more, sufficient adhesion can be obtained. When the use amount of the present binder is 10 parts by mass or less, binders can be uniformly dispersed in the positive electrode active material, so that a mixture layer having a uniform and smooth surface can be formed, which is also preferable from the viewpoint of energy density and electric resistance of a secondary battery.

Of the above-described active materials, a lithium salt of a transition metal oxide can be used as a positive electrode active material, and, for example, layered rock salt-type and spinel-type lithium-containing metal oxides can be used. Examples of specific compounds of the layered rock salt-type positive electrode active material include lithium cobaltate, lithium nickelate, as well as NCM{Li(Niₓ, Co_{y},Mn_{z}), x+y+z=1} and NCA{Li(Ni_{1-a-b}COₐAl_{b})} which are called ternary systems. Examples of the spinel-type positive electrode active material include lithium manganate. In addition to the oxides, phosphate, silicate, sulfur, and the like are used, and examples of the phosphate include olivine-type lithium iron phosphate. As the positive electrode active material, one of the above-described ones may be used alone, or two or more thereof may be used in combination as a mixture or a composite.

From the viewpoint of increasing the energy density of a secondary battery, the use amount of the active material in the present powdery particle composite is preferably in the range of 70 to 99.9 mass %, more preferably in the range of 80 to 99.9 mass %, and further preferably in the range of 90 to 99.9 mass % with respect to the total amount of the present powdery particle composite.

Since all of the positive electrode active materials have low electrical conductivity, a conductive auxiliary agent is generally added and used. Examples of the conductive auxiliary agent include carbon-based materials such as carbon black, carbon nanotube, carbon fiber, graphite fine powder, and carbon fiber. Among these, carbon black, carbon nanotube, and carbon fiber are preferable from the viewpoint of easily obtaining excellent conductivity. Further, as the carbon black, Ketjen black and acetylene black are preferable. As the conductive auxiliary agent, one of the above-described ones may be used alone, or two or more thereof may be used in combination. From the viewpoint of achieving both conductivity and energy density, the use amount of the conductive auxiliary agent can be, for example, 0.2 to 20 parts by mass, or, for example, 0.2 to 10 parts by mass with respect to 100 parts by mass of the total amount of the active material. Further, the positive electrode active material may be surface-coated with a conductive carbon-based material.

The present powdery particle composite may further include another binder components such as styrene butadiene rubber (SBR), carboxymethyl cellulose (CMC), or polyvinylidene fluoride. When another binder component is further used, the use amount thereof can be, for example, 0.1 to 5 mass % or less, can be, for example, 0.1 to 2 mass % or less, or can be, for example, 0.1 to 1 mass % or less with respect to the active material. When the use amount of another binder component exceeds 5 mass %, resistance may increase, and high-rate characteristics may be insufficient. Among them, SBR and CMC are preferable from the viewpoint of achieving an excellent balance between binding properties and bending resistance, and SBR and CMC are more preferably used in combination.

The SBR refers to a copolymer having a structural unit derived from an aromatic vinyl monomer such as styrene and a structural unit derived from an aliphatic conjugated diene-based monomer such as 1,3-butadiene. Examples of the aromatic vinyl monomer include α-methylstyrene, vinyltoluene, and divinylbenzene in addition to styrene, and one or two or more thereof can be used. The structural unit derived from the aromatic vinyl monomer in the copolymer can be, for example, in the range of 20 to 70 mass %, or, for example, in the range of 30 to 60 mass % mainly from the viewpoint of binding properties.

Examples of the aliphatic conjugated diene-based monomer include 2-methyl-1,3-butadiene, 2,3-dimethyl-1,3-butadiene, and 2-chloro-1,3-butadiene in addition to 1,3-butadiene, and one or two or more thereof can be used. The structural unit derived from the aliphatic conjugated diene-based monomer in the copolymer can be, for example, in the range of 20 to 70 mass %, or, for example, in the range of 30 to 60 mass % from the viewpoint of improving the binding properties of binders and the flexibility of the resulting electrode.

In order to further improve performance such as binding properties, the SBR may contain, as another monomer, a nitrile group-containing monomer such as (meth)acrylonitrile, a carboxyl group-containing monomer such as (meth)acrylic acid, itanconic acid, or maleic acid, or an ester group-containing monomer such as methyl (meth)acrylate, as a copolymerization monomer, other than the above-described monomers.

The structural unit derived from the above-described another monomer in the copolymer can be, for example, in the range of 0 to 30 mass %, or, for example, in the range of 0 to 20 mass %.

The CMC refers to a substituted product obtained by substituting a nonionic cellulose-based semi-synthetic polymer compound with a carboxymethyl group, and a salt thereof. Examples of the nonionic cellulose-based semi-synthetic polymer compound include: alkyl celluloses such as methyl cellulose, methyl ethyl cellulose, ethyl cellulose, and microcrystalline cellulose; and hydroxyalkyl celluloses such as hydroxyethyl cellulose, hydroxybutyl methyl cellulose, hydroxypropyl cellulose, hydroxypropyl methyl cellulose, hydroxyethyl methyl cellulose, hydroxypropyl methyl cellulose stearoxy ether, carboxymethyl hydroxyethyl cellulose, alkyl hydroxyethyl cellulose, and nonoxynyl hydroxyethyl cellulose.

The powdery particle composite of the present invention includes the above-described positive electrode active material and the present binder as essential constituent components, and a method for mixing the respective components is not particularly limited. Although a known method can be adopted, a production method of dry-blending a powder component such as a conductive auxiliary agent as necessary in addition to the constituent components is preferred.

The powdery particle composite of the present invention may be mixed with a dispersion medium such as water and then dispersed and kneaded to produce an electrode slurry. Examples of the dispersion medium include, in addition to water, lower alcohols such as methanol and ethanol, carbonates such as ethylene carbonate, ketones such as acetone, and water-soluble organic solvents such as tetrahydrofuran and N-methylpyrrolidone.

### 3. Secondary Battery Positive Electrode

The secondary battery positive electrode of the present invention includes a mixture layer formed from the powdery particle composite of the present invention on the surface of a current collector such as aluminum. The mixture layer is compression-treated by a die press, a roll press, or the like after the present powdery particle composite is applied to the surface of the current collector. By the compression treatment, the active material and the binder can be brought into close contact with each other, and strength of the mixture layer and adhesion of the mixture layer to the current collector can be improved. The thickness of the mixture layer can be adjusted to, for example, about 30 to 80% of that before compression treatment, and the thickness of the mixture layer after compression treatment is generally about 4 to 200 μm.

### 4. Secondary Battery

A secondary battery can be produced by providing the secondary battery positive electrode of the present invention with a secondary battery negative electrode, a separator, and an electrolytic solution. The electrolytic solution may be liquid or gel.

The separator is disposed between the positive electrode and the negative electrode of the battery, and plays a role of preventing a short circuit due to contact between both electrodes and holding the electrolytic solution to ensure ion conductivity. The separator is preferably a film-like insulating microporous membrane having good ion permeability and mechanical strength. As a specific material, polyolefins such as polyethylene and polypropylene, polytetrafluoroethylene, and the like can be used.

Examples of a negative electrode active material used in the secondary battery negative electrode include a carbon-based material, a lithium metal, a lithium alloy, and a metal oxide. One or two or more thereof can be used in combination. Among them, negative electrode active materials (hereinafter, also referred to as “carbon-based negative electrode active materials”) made of carbon-based materials such as natural graphite, artificial graphite, hard carbon, and soft carbon are preferable, and graphites such as natural graphite and artificial graphite, and hard carbon are more preferable. In addition, in the case of graphite, spheroidized graphite is suitably used from the viewpoint of battery performance, and a preferable range of the particle size is, for example, 1 to 20 μm or, for example, 5 to 15 μm. In addition, in order to increase the energy density, a metal, a metal oxide, or the like, capable of absorbing lithium, such as silicon or tin, can be used as the negative electrode active material. Among them, silicon has a higher capacity than graphite, and a negative active material made of a silicon-based material (hereinafter, also referred to as “silicon-based negative electrode active material”) such as silicon, a silicon alloy, and a silicon oxide such as silicon monoxide (SiO) can be used. However, the silicon-based negative electrode active material has a high capacity but has a large volume change due to charging and discharging. Therefore, it is preferable to use the carbon-based negative electrode active material in combination. In this case, when the blending amount of the silicon-based negative electrode active material is large, the electrode material may collapse, and the cycle characteristics (durability) may be greatly deteriorated. From such a viewpoint, when the silicon-based negative electrode active material is used in combination, the use amount is, for example, 60 mass % or less or, for example, 30 mass % or less relative to the carbon-based negative electrode active material.

Since the carbon-based negative electrode active material itself has good electrical conductivity, it is not always necessary to add the conductive auxiliary agent. When the conductive auxiliary agent is added for the purpose of further reducing the resistance, or the like, the use amount is, for example, 10 mass % or less or, for example, 5 mass % or less with respect to the total amount of the negative electrode active material from the viewpoint of the energy density.

As the electrolytic solution, a generally used known electrolytic solution can be used depending on the type of the active material. In a lithium ion secondary battery, specific solvents include cyclic carbonates having a high dielectric constant and a high electrolyte dissolving ability such as propylene carbonate and ethylene carbonate, and chain carbonates having a low viscosity such as ethyl methyl carbonate, dimethyl carbonate, and diethyl carbonate. These can be used alone or as a mixed solvent. The electrolytic solution is used by dissolving a lithium salt such as LiPF₆, LiSbF₆, LiBF₄, LiClO₄, or LiAlO₄ in these solvents. In a nickel-hydride secondary battery, a potassium hydroxide aqueous solution can be used as the electrolytic solution. A secondary battery is obtained by forming a positive electrode plate and a negative electrode plate separated by a separator into a spiral or laminated structure and storing them in a case or the like.

As described above, the secondary battery including the electrode provided with the mixture layer formed of the powdery particle composite disclosed in the present specification is expected to exhibit good durability (cycle characteristics) even when charging and discharging are repeated, and thus is suitable for an on-vehicle secondary battery and the like.

### EXAMPLES

Hereinafter, the present disclosure will be specifically described based on Examples. Note that the present disclosure is not limited to these Examples. Note that in the following description, “parts” and “%” respectively mean parts by mass and mass % unless otherwise specified.

In the following examples, the polymer was evaluated by the following method.

### <Measurement of Particle Diameter>

After diluting 0.02 g of an aqueous dispersion containing the polymer with 20 g of pure water about 1000 times, the particle size distribution was measured using a particle diameter measurement system (NanoSAQLA manufactured by Otsuka Electronics Co., Ltd.) by a dynamic light scattering method to obtain a volume-based median diameter (D50) as a representative value of the particle diameter.

### <Measurement of Glass Transition Temperature>

Using a differential scanning calorimeter (DSC 214 Polyma manufactured by NETZSCH, standard substance: alumina), the calorimetric change point when the polymer was raised from −50° C. to 150° C. at 10° C./min was defined as a glass transition temperature.

<Fusion Property of Polymer after Drying at 70° C.>

A: After drying, the polymer becomes powdery without being fused.

B: After drying, the polymer is fused to form a film, and does not become powdery.

### <Measurement of Solid Content Concentration>

About 0.5 g of the polymer was collected in a weighing bottle [weight of weighing bottle=B (g)] of which the weight had been measured in advance, and was accurately weighed together with the weighing bottle [W₀ (g)]. Then, the polymer was housed in a circulation dryer together with the weighing bottle and dried at 155° C. for 45 minutes. The weight at that time was measured together with the weighing bottle [W₁ (g)], and the solid concentration was determined by the following mathematical expression (1).

$$Solid content concentration ( \% ) = ( {W}_{1} - B ) / ( {W}_{0} - B ) \times 100 \qquad ( 1 )$$

### <<Production of Polymer>>

### Production Example 1: Production of Polymer R-1

For polymerization, a reaction vessel equipped with a stirring blade, a thermometer, a reflux condenser, and a nitrogen inlet tube was used.

In a nitrogen atmosphere, 50 parts of water was charged into the reaction vessel and heated to 70° C.

Next, 40 parts of water, 2.0 parts of sodium lauryl sulfate (trade name “EMAL 2F-30” manufactured by Kao Corporation) as a surfactant in terms of solid equivalent, 95 parts of styrene, 4 parts of 2-ethylhexyl acrylate, and 1 part of methacrylic acid were added into another container equipped with a stirring blade, and emulsified to prepare a mixed solution.

Further, 0.2 part of ammonium persulfate (hereinafter, also referred to as “APS”) as a polymerization initiator was added to the reaction vessel, and then the mixed solution in an emulsified state was added into the reaction vessel at a constant rate over 3 hours. Further, a liquid prepared in advance in another container and obtained by mixing 0.2 part of APS and 10 parts of water was added into the reaction liquid at a constant rate over 3 hours.

The reaction was carried out until the polymerization conversion rate exceeded 98% to obtain an aqueous dispersion of polymer R-1. The particle diameter of polymer R-1 was 260 nm.

### Production Examples 2 to 15 and Comparative Production Examples 1 to 2: Production of Polymers R-2 to R-17

An aqueous dispersion of each of polymers R-2 to R-17 was obtained in the same operation as in Production Example 1 except that the charged amount of each raw material was changed as shown in Table 1. The measurement results of the particle diameters of polymers R-2 to R-17 are shown in Table 1.

### <<Production of Powdery Binder for Secondary Battery Positive Electrode>>

### Production Example 1: Production of Powdery Binder R-1 for Secondary Battery Positive Electrode

After the aqueous dispersion of polymer R-1 obtained in Production Example 1 was dried in a circulation dryer at 70° C., the polymer was not fused (evaluation A). Further, drying was performed under conditions of a vacuum dryer at 2 kPa, 60° C., and 4 hours. The obtained solid was pulverized to obtain a powdery binder R-1 for a secondary battery positive electrode containing polymer R-1. For polymer R-1, the glass transition point temperature was 92° C., and the solid content concentration was 99.2 mass %.

### Production Examples 2 to 15 and Comparative Production Examples 1 to 2: Production of Powdery Binders R-2 to R-17 for Secondary Battery Positive Electrodes

The aqueous dispersions of polymers R-2 to R-17 obtained in Production Examples 2 to 15 and Comparative Production Examples 1 to 2 were subjected to drying treatment in the same manner as in Production Example 1 to obtain powdery binders R-2 to R-17 for secondary battery positive electrodes containing polymers R-2 to R-17, respectively. For polymers R-2 to R-17, the glass transition point temperature, evaluation result of a fusion property after drying at 70° C., and solid concentration are shown in Table 1.

TABLE 1

| Production Example | | | Pro- | Pro- | Pro- | Pro- | Pro- | Pro- | Pro- | Pro- | Pro- |
|---|---|---|---|---|---|---|---|---|---|---|---|
| Comparative | | | duction | duction | duction | duction | duction | duction | duction | duction | duction |
| Production | | | Exam- | Exam- | Exam- | Exam- | Exam- | Exam- | Exam- | Exam- | Exam- |
| Example No. | | | ple 1 | ple 2 | ple 3 | ple 4 | ple 5 | ple 6 | ple 7 | ple 8 | ple 9 |
| Polymer No. | | | R-1 | R-2 | R-3 | R-4 | R-5 | R-6 | R-7 | R-8 | R-9 |
| Non- [symbol] | (a1) | St | 94 | 94 | 94 | 94 | 94 | 94 | 90 | 80 | 92 |
| monomer | (a2) | HA | 5 | 5 | 5 | 5 | 5 | 5 | 5 | 9 | |
| | | BA | | | | | | | | | 7 |
| | | MMA | | | | | | | | | |
| | | IBOMA | | | | | | | | | |
| | (a3) | MAA | 1 | 1 | 1 | 1 | 1 | 1 | 5 | 10 | 1 |
| | | AN | | | | | | | | | |
| Surfactant | Surfactant 1 | | 2.0 | 6.0 | 3.5 | 1.3 | 1.0 | 0.50 | 2.0 | 20 | 2.0 |
| | Surfactant 2 | | | | | | | | | | |
| [symbol] | AMA | | | | | | | | | | |
| monomer | | | | | | | | | | | |
| Polymerization | APS | | 0.40 | 0.40 | 0.40 | 0.40 | 0.40 | 0.40 | 0.40 | 0.40 | 0.40 |
| [symbol] | | | | | | | | | | | |
| Solid content concentrarion during | | | 48% | 48% | 48% | 48% | 48% | 48% | 48% | 48% | 48% |
| polymerization | | | | | | | | | | | |
| Characteristics | Particle diameter (nm) | | 260 | 140 | 90 | 510 | 700 | 900 | 450 | 450 | 270 |
| of polyster | Glass transition | | 92 | 92 | 92 | 92 | 92 | 92 | 92 | 94 | 88 |
| | temperature (° C.) | | | | | | | | | | |
| | Fusion after drying at 20° C. | | A | A | A | A | A | A | A | A | A |
| | Solid content concentration | | 99.2% | 95.5% | 99.4% | 98.9% | 98.5% | 98.3% | 99.0% | 98.8% | 99.1% |
| | after crying | | | | | | | | | | |
| Production Example | | | Pro- | Pro- | Pro- | Pro- | Pro- | Pro- | Com- | Com- | |
| Comparative | | | duction | duction | duction | duction | duction | duction | parative | parative | |
| Production | | | Exam- | Exam- | Exam- | Exam- | Exam- | Exam- | Production | Production | |
| Example No. | | | ple 10 | ple 11 | ple 12 | ple 13 | ple 14 | ple 15 | Example 1 | Example 2 | |
| Polymer No. | | | R-10 | R-11 | R-12 | R-13 | R-14 | R-15 | R-16 | R-17 | |
| Non- [symbol] | (a1) | St | | 85 | 50 | 70 | 55 | 94 | 94 | 75 | |
| monomer | (a2) | HA | | 14 | 19 | | | 5 | 5 | 24 | |
| | | BA | | | | | | | | | |
| | | MMA | 99 | | | | | | | | |
| | | IBOMA | | | | | 44 | | | | |
| | (a3) | MAA | 1 | 1 | 1 | 1 | 1 | 1 | 1 | 1 | |
| | | AN | | | | | | | | | |

| Surfactant | Surfactant 1 | 2.0 | 2.0 | 2.0 | 2.0 | 2.0 | | 2.0 | 20 |
|---|---|---|---|---|---|---|---|---|---|
| | Surfactant 2 | | | | | | 4.0 | | |
| [symbol] | AMA | | | | | | | 1.0 | |
| monomer | | | | | | | | | |
| Polymerization | APS | 0.40 | 0.40 | 0.40 | 0.40 | 0.40 | 0.40 | 0.40 | 0.40 |
| [symbol] | | | | | | | | | |
| Solid content concentrarion during | | 48% | 48% | 48% | 48% | 48% | 48% | 48% | 48% |
| polymerization | | | | | | | | | |
| Characteristics | Particle diameter (nm) | 600 | 260 | 260 | 330 | 200 | 220 | 130 | 360 |
| of polyster | Glass transition | 108 | 73 | 63 | 109 | 150 | 91 | 92 | 50 |
| | temperature (° C.) | | | | | | | | |
| | Fusion after drying at 20° C. | A | A | B | A | A | A | A | B |
| | Solid content concentration | 99.3% | 99.1% | 99.3% | 99.2% | 99.3% | 97.3% | 99.2% | 99.4% |
| | after crying | | | | | | | | |

[symbol]

indicates data missing or illegible when filed

Details of compounds used in Table 1 are shown below.
St: styrene
HA: 2-Ethylhexyl acrylate
BA: n-Butyl acrylate
MMA: Methyl methacrylate
IBOMA: Isobornyl methacrylate
MAA: Methacrylic acid
AN: Acrylonitrile
Surfactant 1: 30% Aqueous solution of sodium lauryl sulfate (trade name “EMAL 2F-30” manufactured by Kao Corporation)
Surfactant 2: 25% Aqueous solution of polyoxyethylene styrenated propenylphenyl ether sulfuric acid ester ammonium (trade name “Aqualon AR-1025” manufactured by DKS Co. Ltd.)
AMA: Allyl methacrylate (crosslinkable monomer)
APS: Ammonium persulfate

### Example 1

### <Evaluation of Dispersibility of Powdery Binder in Active Material)

In a container, 99 parts of LiNi_{0.8}Co_{0.15}Al_{0.05}O₂ (NCA) as a positive electrode active material, 1 part of a powdery binder (R-1) containing polymer R-1, and 100 parts of zirconia beads (φ=1 mm) were put, and mixed for 60 minutes using a paint shaker to attach the binder to the positive electrode active material and uniformly disperse the binder, so that a powdery particle composite was obtained. Thereafter, the dispersion state of the binder was visually evaluated. The evaluation result is shown in Table 2.

### (Criteria for Evaluation of Dispersibility in Active Material)

A: After the positive electrode active material is dispersed, white color of the binder is not observed.
B: After the positive electrode active material is dispersed, white color of the binder can be visually observed, but no lump remains.
C: After the positive electrode active material is dispersed, a large lump of the binder remains.
Evaluation B or higher is an acceptable level.

### <Evaluation of Adhesion of Powdery Binder to Active Material>

The powdery particle composite obtained as described above was sandwiched between two aluminum foils (20 μm, manufactured by UACJ), and subjected to compression treatment at “120° C., 10 minutes, press pressure: 3 MPa” or compression treatment at “150° C., 10 minutes, press pressure: 3 MPa”.

After the compression treatment, adhesion to the positive electrode active material when the aluminum foils were peeled off was evaluated.

Adhesion was evaluated from the amount of an unbound active material that was shaken off 10 times from the aluminum foils after the compression treatment with a brush and slid down. The evaluation result is shown in Table 2.

### (Criteria for Judgment of Adhesion to Active Material)

A: The sliding-down amount of the active material is less than 10%.
B: The sliding-down amount of the active material is 10% or more and less than 30%.
C: The sliding-down amount of the active material is 30% or more.

The smaller the sliding-down amount of the active material, the better the binding of the binder, and evaluation B or higher is an acceptable level.

### Examples 2 to 18 and Comparative Examples 1 to 2

A powdery particle composite was obtained by performing the same operation as in Example 1 except that the formulation was as shown in Table 2, and dispersibility of the powdery binder in the active material and adhesion of the powdery binder to the active material were evaluated. The results are shown in Table 2.

TABLE 2

| | | | | Exam- | Exam- | Exam- | Exam- | Exam- | Exam- | Exam- | Exam- | Exam- | Exam- |
|---|---|---|---|---|---|---|---|---|---|---|---|---|---|
| Example Comparative Example No. | | | | ple 1 | ple 2 | ple 3 | ple 4 | ple 5 | ple 6 | ple 7 | ple 8 | ple 9 | ple 10 |
| Powdery | Positive electrode | NCA | | 99 | 97 | | 97 | 99 | 99 | 99 | 99 | 99 | 99 |
| particle | active material | NMC | | | | 99 | | | | | | | |
| composite | Conductive | AB | | | 2 | | | | | | | | |
| | auxiliary agent | | | | | | | | | | | | |
| | Powdery | Polymer | Type | R-1 | R-1 | R-1 | R-1 | R-2 | R3 | R-4 | R-5 | R-6 | R-7 |
| | binder | | Parts | 1 | 1 | 1 | 3 | 1 | 1 | 1 | 1 | 1 | 1 |
| Evaluation | Dispersibility in active material | | | A | A | A | A | A | A | A | A | B | A |
| result | Adhesion to | 120° C. 10 min, 3 MPa | | A | A | A | A | A | A | A | B | B | B |
| | active material | 150° C. 10 min, 3 MPa | | A | A | A | A | A | A | A | A | B | A |
| | | | | | | | | | | | | Com- | Com- |
| | | | | | | | | | | | | parative | parative |
| | | | | Exam- | Exam- | Exam- | Exam- | Exam- | Exam- | Exam- | Exam- | Exam- | Exam- |
| Example Comparative Example No. | | | | ple 11 | ple 12 | ple 13 | ple 14 | ple 15 | ple 16 | ple 17 | ple 18 | ple 1 | ple 2 |
| Powdery | Positive electrode | NCA | | 99 | 99 | 99 | 99 | 99 | 99 | 99 | 99 | 99 | 99 |
| particle | active material | | | | | | | | | | | | |
| | Powdery | Polymer | Type | R-8 | R-9 | R-10 | R-11 | R-12 | R-13 | R-14 | R-15 | R-16 | R-17 |
| composite | binder | | Parts | 1 | 1 | 1 | 1 | 1 | 1 | 1 | 1 | 1 | 1 |

| Evaluation | Dispersibility in active material | | A | A | A | A | B | A | A | A | A | C |
|---|---|---|---|---|---|---|---|---|---|---|---|---|
| result | Adhesion to | 120° C. 10 min, 3 MP3 | B | A | B | A | B | B | C | A | C | B |
| | ective material | 150° C. 10 minn 3 MPa | B | A | A | A | B | A | B | A | C | B |

Details of compounds used in Table 2 are shown below.
NCA: LiNi_{0.8}Co_{0.15}Al_{0.05}O₂ (trade name “NCA7051” manufactured by BASF Toda Battery Materials LLC)
NMC: LiNi_{1/3}Co_{1/3}Mn_{1/3}O₂ (trade name “NCM111 1040” manufactured by BASF Toda Battery Materials LLC)
AB: Acetylene black (trade name “Denka Black Li-400” manufactured by Denka Company Limited)

### <<Evaluation Results>>

As is apparent from the results of Examples 1 to 18, use of the powdery binder for a secondary battery positive electrode of the present invention enables production of a positive electrode by dry blending instead of an electrode slurry, and therefore productivity was excellent, and dispersibility of the powdery binder in the active material and adhesion of the powdery binder to the active material were excellent.

Focusing on the glass transition temperature, the dispersibility of the powdery binder in the active material was more excellent when the glass transition temperature was 70° C. or higher (Examples 1, 14, 16, and 17) than when the glass transition temperature was 63° C. (Example 15). When the glass transition temperature was in the range of 73° C. to 109° C., the adhesion of the powdery binder to the active material was evaluation B or higher under both the compression treatment condition of 120° C. and the compression treatment condition of 150° C. (Examples 1, 14, and 16).

Furthermore, focusing on the amount of the structural unit derived from the ethylenically unsaturated carboxylic acid monomer, the adhesion to the active material was more excellent when the amount of the structural unit derived from methacrylic acid was 5% by mass or less (Examples 1 and 10) than when the amount was 10% by mass (Example 11).

Furthermore, focusing on the particle diameter, the adhesion to the active material was excellent under the compression treatment condition of 150° C. when the particle diameter is in the range of 90 nm to 700 nm (Examples 1 and 5 to 8), and the adhesion to the active material was excellent even under the compression treatment condition of 120° C. when the particle diameter is in the range of 90 nm to 510 nm (Examples 1 and 5 to 7).

On the other hand, the powdery binder containing a crosslinked polymer having a structural unit derived from a crosslinkable monomer was remarkably poor in adhesion to the active material (Comparative Example 1). This is considered to be because the crosslinked polymer does not melt and does not cover the positive electrode active material under the compression treatment conditions at a high temperature (120° C. and 150° C.). In addition, when the glass transition temperature of the non-crosslinked polymer was lower than 60° C. (Comparative Example 2), powdery binders were fused to each other, so that the dispersibility of the powdery binder in the active material was significantly poor.

### INDUSTRIAL APPLICABILITY

Since the powdery binder for a secondary battery positive electrode disclosed in the present specification enables production of a positive electrode for a secondary battery by dry blending without using an electrode slurry, productivity is excellent, and dispersibility of the powdery binder in an active material and adhesion to the active material are excellent.

Furthermore, a secondary battery including a secondary battery positive electrode obtained using the powdery binder is estimated to achieve good integrity and exhibit good durability (cycle characteristics) even when charging and discharging are repeated, and thus is expected to contribute to increasing the capacity of a vehicle-mounted secondary battery or the like.

The powdery binder for the secondary battery positive electrode of the present invention can be particularly suitably used for a nonaqueous electrolyte secondary battery positive electrode, and is particularly useful for a nonaqueous electrolyte lithium ion secondary battery having high energy density.

1. A powdery binder for a secondary battery positive electrode, comprising a non-crosslinked polymer having a glass transition temperature of 60° C. or higher and 150° C. or lower.

2. The powdery binder for a secondary battery positive electrode according to claim 1, wherein the non-crosslinked polymer has a structural unit derived from a non-crosslinkable ethylenically unsaturated monomer.

3. The powdery binder for a secondary battery positive electrode according to claim 2, wherein the non-crosslinkable ethylenically unsaturated monomer includes a non-crosslinkable aromatic vinyl monomer or a non-crosslinkable ethylenically unsaturated carboxylic acid ester monomer.

4. The powdery binder for a secondary battery positive electrode according to claim 1, wherein the non-crosslinked polymer has 5 mass % or less of a structural unit derived from a non-crosslinkable ethylenically unsaturated carboxylic acid monomer with respect to all structural units of the non-crosslinked polymer.

5. The powdery binder for a secondary battery positive electrode according to claim 1, wherein a particle diameter of the non-crosslinked polymer is 80 nm to 800 nm as a volume-based median diameter (D50) measured by a dynamic light scattering method.

6. A powdery particle composite comprising a positive electrode active material and the powdery binder for a secondary battery positive electrode according to claim 1.

7. A secondary battery positive electrode comprising a mixture layer formed from the powdery particle composite according to claim 6 on a surface of a current collector.

8. A secondary battery comprising the secondary battery positive electrode according to claim 7.
